(19) United States
(12) Patent Application Publication
(10) Pub. No.: US 2023/0034163 A1
(43) Pub. Date: Feb. 2, 2023

(54) COMMUNICATION METHOD UTILIZING MULTIPLE WIRELESS ACCESS POINTS AND APPARATUS THEREFOR

(71) Applicant: ELECTRONICS AND TELECOMMUNICATIONS RESEARCH INSTITUTE, Daejeon (KR)

(72) Inventor: Jae Heung KIM, Daejeon (KR)

(21) Appl. No.: 17/872,087

(22) Filed: Jul. 25, 2022

(30) Foreign Application Priority Data
Jul. 28, 2021 (KR) 10-2021-0099375
Jul. 18, 2022 (KR) 10-2022-0088168

(51) Int. Cl. H04W 48/20; H04W 24/10; H04W 76/30

(52) U.S. Cl. CPC H04W 48/20; H04W 24/10; H04W 76/30

(57) ABSTRACT

An operation method of a terminal in a mobile communication system may include: receiving configuration information for support of an mTRP function from a first base station through a first TRP belonging to the first base station; detecting and selecting a second TRP supporting the mTRP function based on the configuration information; transmitting a measurement report for the second TRP or a first control message requesting support of the mTRP function in which the second TRP participates to the first base station through the first TRP; and receiving a second control message indicating a start of the mTRP function in which the first TRP and the second TRP participate from the first base station through the first TRP or the second TRP.

### CROSS-REFERENCE TO RELATED APPLICATIONS

This application claims priority to Korean Patent Applications No. 10-2021-0099375 filed on Jul. 28, 2021, and No. 10-2022-0088168 filed on Jul. 18, 2022, with the Korean Intellectual Property Office (KIPO), the entire contents of which are hereby incorporated by reference.

### BACKGROUND

### 1. Technical Field

The present disclosure relates to a mobile communication system, and more particularly, to a communication method for achieving performance improvement by utilizing multiple wireless access points (e.g., transmission and reception point (TRP), remote radio head (RRH), relay, repeater, etc.) in a mobile communication system using a high frequency band above a millimeter wave (mmWave) band.

### 2. Description of Related Art

In order to cope with the rapidly increasing wireless data, a mobile communication system considers a transmission frequency band of 6 GHz to 90 GHz for a wide system bandwidth. Methods of utilizing wireless access points (e.g., TRP, RRH, relay, repeater, etc.) to overcome degradation of received signal performance due to attenuation and reflection of radio waves in the such the high frequency band and to improve terminal performance at an edge of a coverage of a base station (or cell) are being considered.

In order to deploy a mobile communication system based on small base stations having small service coverages in consideration of the millimeter wave frequency band of 6 GHz to 90 GHz, a functional split scheme in which functions of a base station are configured as being split into a plurality of remote radio transmission and reception blocks and one centralized baseband processing block may be applied instead of deploying small base stations in which all of radio protocol functions of the mobile communication system are implemented. In addition, a method of configuring the mobile communication system by utilizing a plurality of TRPs (or RRH, relay, repeater, etc.) using functions such as carrier aggregation, dual connectivity, duplication transmission, and the like may be considered.

In a mobile communication system to which such the functional split scheme, bi-casting function, or duplication transmission function is applied, there is a need for a radio resource management procedure, control signaling procedure, and operational procedure for providing services to a terminal by using a plurality of wireless access points (e.g., TRP, RRH, relay, repeater, etc.) belonging to network nodes (e.g., eNB, gNB, cell, etc.) identified by different identifiers.

### SUMMARY

Accordingly, exemplary embodiments of the present disclosure are directed to providing a communication method for achieving performance improvement by utilizing multiple wireless access points (e.g., TRP, RRH, relay, repeater, etc.).

Accordingly, exemplary embodiments of the present disclosure are also directed to providing configuration of an apparatus (e.g., terminal or base station) for performing the communication method.

According to a first exemplary embodiment of the present disclosure, an operation method of a terminal in a mobile communication system may comprise: receiving configuration information for support of a multi-transmission and reception point (mTRP) function from a first base station through a first TRP belonging to the first base station; detecting and selecting a second TRP supporting the mTRP function based on the configuration information; transmitting a measurement report for the second TRP or a first control message requesting support of the mTRP function in which the second TRP participates to the first base station through the first TRP; and receiving a second control message indicating a start of the mTRP function in which the first TRP and the second TRP participate from the first base station through the first TRP or the second TRP.

The configuration information may include information on neighboring TRP(s) and/or candidate TRP(s), and the terminal may detect and select the second TRP based on the information on the neighboring TRP(s) and/or the candidate TRP(s).

The second TRP may be selected based on whether the second TRP satisfies mTRP function support condition(s), and the mTRP function support condition(s) may be at least one of: when a quality of a radio channel between the terminal and the first base station or the first TRP is less than a reference value; when the terminal is located at an edge of a service coverage of the first base station or the first TRP; when a transmission frequency, frequency band, and/or bandwidth part (BWP) of the second TRP satisfies a priority for supporting the mTRP function; when a quality of a radio channel between the terminal and the second TRP is greater than or equal to a preset reference value; when the quality of the radio channel between the terminal and the second TRP is maintained above a preset reference value until a predefined timer expires; or a combination thereof.

The second TRP may belong to the first base station or belong to a second base station different from the first base station.

The mTRP function may be controlled by an mTRP L2/L3 entity operating in a medium access control (MAC) layer and/or a radio resource control (RRC) layer of the first base station or the second base station.

The operation method may further comprise receiving services by the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.

When the second TRP belongs to the second base station, control information for supporting the mTRP function may be exchanged between the first TRP and the second TRP.

The operation method may further comprise determining whether the first TRP or the second TRP satisfies mTRP function release condition(s), wherein the mTRP function release condition(s) may be at least one of: when a quality of a radio channel between the terminal and the first TRP or the second TRP is less than a reference value until a predefined timer expires; when a random access procedure for the first TRP or the second TRP fails; when a beam failure recovery (BFR) for the first TRP or the second TRP fails; when the mTRP function control base station and/or an mTRP L2/L3 entity belonging to the mTRP function control base station determines to release the mTRP function for the first TRP or the second TRP; when the terminal requests release of the mTRP function or requests to change the first TRP or the second TRP to another TRP; or a combination thereof.

The operation method may further comprise, when the first TRP or the second TRP is determined to satisfy the mTRP function release condition(s), transmitting a third control message requesting release of the mTRP function for the first TRP or the second TRP satisfying the mTRP function release condition(s) through the first TRP or the second TRP.

The operation method may further comprise, when the first TRP or the second TRP is determined to satisfy the mTRP function release condition(s), performing a procedure of replacing the first TRP or the second TRP satisfying the mTRP function release condition(s) with another newly detected TRP.

The first message or the second message may be one of an RRC control message, a MAC control element (CE), a physical layer control message, or a combination thereof.

According to a second exemplary embodiment of the present disclosure, an operation method of a first base station in a mobile communication system may comprise: transmitting configuration information for support of a multi-transmission and reception point (mTRP) function to a terminal through a first TRP belonging to the first base station; receiving a measurement report for a second TRP detected and selected based on the configuration information or a first control message requesting support of the mTRP function in which the second TRP participates from the terminal through the first TRP; and transmitting a second control message indicating a start of the mTRP function in which the first TRP and the second TRP participate to the terminal through the first TRP or the second TRP.

The configuration information may include information on neighboring TRP(s) and/or candidate TRP(s), and the second TRP may be detected and selected by the terminal based on the information on the neighboring TRP(s) and/or the candidate TRP(s).

The second TRP may be selected based on whether the second TRP satisfies mTRP function support condition(s), and the mTRP function support condition(s) may be at least one of: when a quality of a radio channel between the terminal and the first base station or the first TRP is less than a reference value; when the terminal is located at an edge of a service coverage of the first base station or the first TRP; when a transmission frequency, frequency band, and/or bandwidth part (BWP) of the second TRP satisfies a priority for supporting the mTRP function; when a quality of a radio channel between the terminal and the second TRP is greater than or equal to a preset reference value; when the quality of the radio channel between the terminal and the second TRP is maintained above a preset reference value until a predefined timer expires; or a combination thereof.

The second TRP may belong to the first base station or belong to a second base station different from the first base station.

The operation method may further comprise providing services based on the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.

The operation method may further comprise determining whether the first TRP or the second TRP satisfies mTRP function release condition(s), wherein the mTRP function release condition(s) may be at least one of: when a quality of a radio channel between the terminal and the first TRP or the second TRP is less than a reference value until a predefined timer expires; when a random access procedure for the first TRP or the second TRP fails; when a beam failure recovery (BFR) for the first TRP or the second TRP fails; when the mTRP function control base station and/or an mTRP L2/L3 entity belonging to the mTRP function control base station determines to release the mTRP function for the first TRP or the second TRP; when the terminal requests release of the mTRP function or requests to change the first TRP or the second TRP to another TRP; or a combination thereof.

According to a third exemplary embodiment of the present disclosure, a terminal in a mobile communication system may comprise: at least one processor; a memory in which instructions executable by the at least one processor are stored; and a transceiver, wherein when executed by the at least one processor, the instructions cause the terminal to: receive configuration information for support of a multi-transmission and reception point (mTRP) function from a first base station through a first TRP belonging to the first base station; detect and select a second TRP supporting the mTRP function based on the configuration information; transmit a measurement report for the second TRP or a first control message requesting support of the mTRP function in which the second TRP participates to the first base station through the first TRP; and receive a second control message indicating a start of the mTRP function in which the first TRP and the second TRP participate from the first base station through the first TRP or the second TRP.

The second TRP may belong to the first base station or belong to a second base station different from the first base station.

The instructions may further cause the terminal to receive services by the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.

According to the exemplary embodiments of the present disclosure, an mTRP function in which a plurality of wireless access points provide services to a user terminal can be efficiently configured. In particular, conditions for supporting the mTRP function and conditions for releasing the mTRP function are defined, and a procedure for adding a new TRP to support the mTRP function and a procedure for releasing the mTRP function for a TRP performing the mTRP function are defined.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating an exemplary embodiment of operation states of a terminal in a communication system.

FIG. 4 is a conceptual diagram illustrating an exemplary embodiment of a method of configuring bandwidth parts (BWPs) in a communication system.

FIG. 5 is a conceptual diagram illustrating an example of a connection scheme between a base station and a core network in a mobile communication network to which functional split is applied.

FIG. 6 is a conceptual diagram illustrating an example of a connection scheme for supporting a multi-wireless access point function in a mobile communication system.

FIG. 7 is a sequence chart for describing an exemplary embodiment of an operation procedure for supporting the mTRP function in a mobile communication system.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may mean “at least one of A or B” or “at least one of combinations of one or more of A and B”. Also, in exemplary embodiments of the present disclosure, “one or more of A and B” may mean “one or more of A or B” or “one or more of combinations of one or more of A and B”.

In exemplary embodiments of the present disclosure, “(re)transmission” may mean “transmission”, “retransmission”, or “transmission and retransmission”, “(re)configuration” may mean “configuration”, “reconfiguration”, or “configuration and reconfiguration”, “(re)connection” may mean “connection”, “reconnection”, or “connection and reconnection”, and “(re)access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in greater detail with reference to the accompanying drawings. In order to facilitate general understanding in describing the present disclosure, the same components in the drawings are denoted with the same reference signs, and repeated description thereof will be omitted.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may be used in the same sense as a communication network.

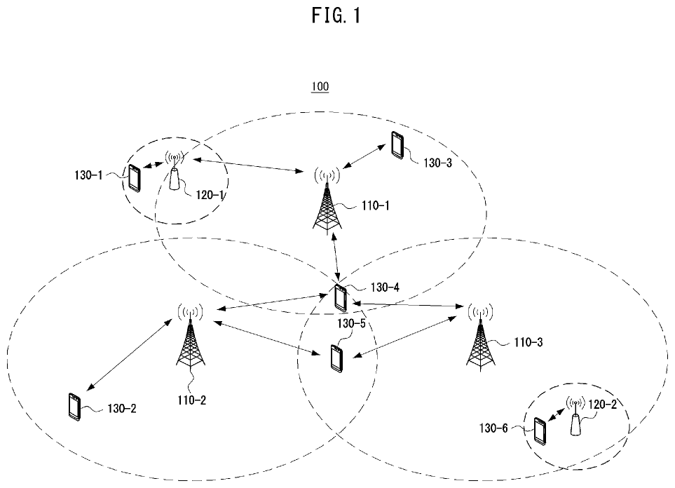

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

Also, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the 5G communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

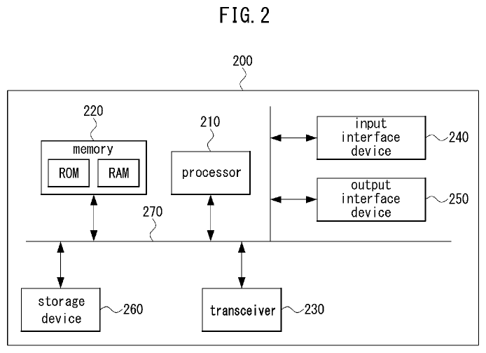

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Each of the plurality of communication nodes 110-1, 110-2, 110-3, 120-1, 120-2, 130-1, 130-2, 130-3, 130-4, 130-5, and 130-6 may support radio protocol specifications of a radio access technology based on cellular communication (e.g., LTE or LTE-Advanced defined by the 3rd generation partnership project (3GPP)) or a mmWave band (e.g., 6 to 80 GHz band). Each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

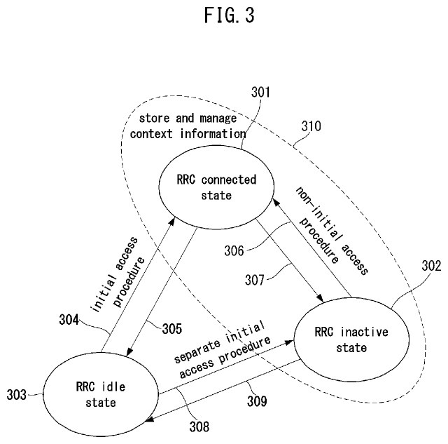

FIG. 3 is a conceptual diagram illustrating an exemplary embodiment of operation states of a terminal in a communication system.

Referring to FIG. 3, in a radio resource control (RRC) layer of the mobile communication system, operation states of the terminal may be classified into an RRC connected state 301, RRC inactive state 302, and RRC idle state 303. When the terminal operates in the RRC connected state 301 or the RRC inactive state 302, a radio access network (RAN) (e.g., a control function block of the RAN) and a base station may store and manage RRC connection configuration information and/or context information (e.g., RRC context information, access stratum (AS) context information) of the terminal (310).

The terminal operating in the RRC connected state 301 may receive configuration information of physical layer control channels and/or reference signals required for maintaining connection configuration and transmission/reception of data from the base station. The reference signal may be a reference signal for demodulating the data. Alternatively, the reference signal may be a reference signal for channel quality measurement or beamforming. Therefore, the terminal operating in the RRC connected state may transmit and receive the data without delay.

In the RRC inactive state 302, the base station of the RAN and the terminal may store and manage RRC connection configuration information or RRC (or AS) context information of the terminal, but only perform mobility management function operations corresponding to the idle state 303. When the terminal operates in the RRC inactive state 302, mobility management functions/operations identical or similar to mobility management functions/operations supported in the RRC idle state may be supported for the corresponding terminal. That is, when the terminal operates in the RRC inactive state, a data bearer for transmitting and receiving data may not be configured, and functions of the MAC layer may be deactivated. Accordingly, the terminal operating in the RRC inactive state may transition the operation state of the terminal from the RRC inactive state to the RRC connected state by performing the non-initial access procedure 306 to transmit data. Alternatively, the terminal operating in the RRC inactive state may transmit data having a limited size, data having a limited quality of service, and/or data associated with a limited service.

The RRC idle state 303 means a state in which there is no connection established between the base station and the terminal from the viewpoint of the RAN, or the base station or the control function block of the RAN does not store connection configuration information or context information of the terminal. When the terminal operates in the RRC idle state, there may be no connection configuration between the terminal and the base station, and the RRC connection configuration information and/or context information (e.g., RRC context information, AS context information) of the terminal may not be stored in the RAN (e.g., a control function block of the RAN) and the base station. In order to transition the operation state of the terminal from the RRC idle state to the RRC connected state, the terminal may perform the initial access procedure. Alternatively, when the initial access procedure is performed, the operation state of the terminal may transition from the RRC idle state to the RRC inactive state according to determination of the base station.

The terminal may transition from the RRC idle state to the RRC inactive state by performing the initial access procedure or a separate access procedure 308 defined for the RRC inactive state. When a limited service is provided to the terminal, the operation state of the terminal may transition from the RRC idle state to the RRC inactive state. Alternatively, depending on capability of the terminal, the operation state of the terminal may transition from the RRC idle state to the RRC inactive state. Such the case in which the terminal in the idle state 303 transitions to the inactive state 302 may be allowed only when a limited service is provided to the terminal or according to the capability of the terminal.

The base station and/or the control function block of the RAN may configure condition(s) for transitioning to the RRC inactive sate by considering one or more of the type, capability, and service (e.g., a service currently being provided and a service to be provided) of the terminal, and may control the operation for transitioning to the RRC inactive state based on the configured condition(s). When the base station allows the transition to the RRC inactive state or when the transition to the RRC inactive state is configured to be allowed, the operation state of the terminal may be transitioned from the RRC connected state or the RRC idle state to the RRC inactive state.

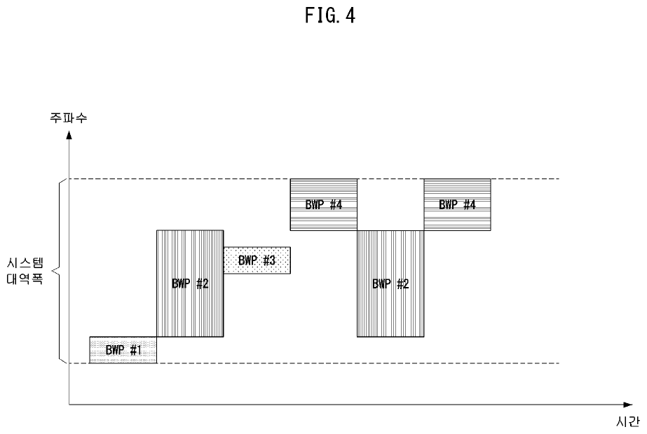

FIG. 4 is a conceptual diagram illustrating an exemplary embodiment of a method of configuring bandwidth parts (BWPs) in a communication system.

A bandwidth part (BWP) may be a bandwidth configured for transmission and reception of the terminal. As shown in FIG. 4, a plurality of bandwidth parts (e.g., BWPs #1 to #4) may be configured within a system bandwidth of the base station. The BWPs #1 to #4 may be configured not to be larger than the system bandwidth of the base station. The bandwidths of the BWPs #1 to #4 may be different, and different subcarrier spacings may be applied to the BWPs #1 to #4. For example, the bandwidth of the BWP #1 may be 10 MHz, and the BWP #1 may have a 15 kHz subcarrier spacing. The bandwidth of the BWP #2 may be 40 MHz, and the BWP #2 may have a 15 kHz subcarrier spacing. The bandwidth of the BWP #3 may be 10 MHz, and the BWP #3 may have a 30 kHz subcarrier spacing. The bandwidth of the BWP #4 may be 20 MHz, and the BWP #4 may have a 60 kHz subcarrier spacing.

The BWPs may be classified into an initial BWP (e.g., first BWP), an active BWP (e.g., activated BWP), and a default BWP. The terminal may perform an initial access procedure (e.g., access procedure) with the base station in the initial BWP. One or more BWPs may be configured through an RRC connection configuration message, and one BWP among the one or more BWPs may be configured as the active BWP. Each of the terminal and the base station may transmit and receive packets in the active BWP among the configured BWPs. Therefore, the terminal may perform a monitoring operation on control channels for packet transmission and reception in the active BWP.

The terminal may switch the operating BWP from the initial BWP to the active BWP or the default BWP. Alternatively, the terminal may switch the operating BWP from the active BWP to the initial BWP or the default BWP. The BWP switching operation may be performed based on an indication of the base station or a timer. The base station may transmit information indicating the BWP switching to the terminal using one or more of an RRC message, a MAC message (e.g., MAC control element (CE)), and a PHY message (e.g., DCI). The terminal may receive the information indicating the BWP switching from the base station, and may switch the operating BWP of the terminal to a BWP indicated by the received information.

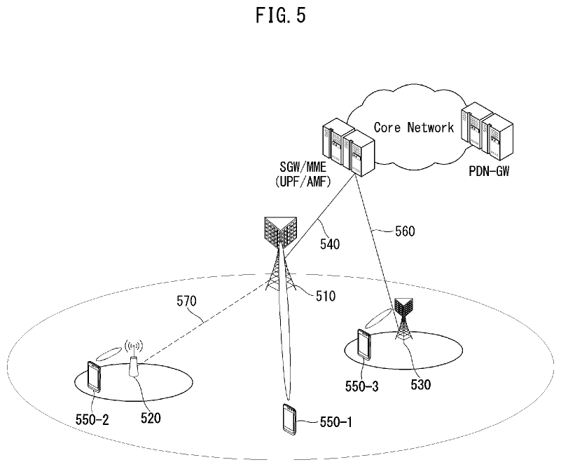

FIG. 5 is a conceptual diagram illustrating an example of a connection scheme between a base station and a core network in a mobile communication network to which functional split is applied.

Referring to FIG. 5, a base station 510 (or macro base station) or a small base station 530 may be connected to a termination node of the core network through a backhaul 540 or 560. Here, the termination node of the core network may be a serving gateway (SGW), a user plane function (UPF), a mobility management entity (MME), or an access and mobility function (AMF).

In addition, the base stations 510 and 530 to which the functional split scheme is applied (e.g., eNB of the 3GPP LTE/LTE-A system or gNB of the 3GPP NR system) may be configured with a central unit (CU) and at least one distributed unit (DU). The CU of the base station may be a logical node that performs RRC, SDAP, and PDCP layer functions of the radio access protocol, and may control operations of one or more DUs. The CU of the base station may be connected to the termination node of the core network using the backhaul 540 or 560 based on an S1 interface (in case of the 3GPP LTE/LTE-A system) or NG interface (in case of the 3GPP NR system).

The DU of the base station may be a logical node that performs RLC, MAC, and PDCP layer functions of the base station, and support one or more cells. In addition, the CU and the DU of the base station may be connected in a wired or wireless manner (e.g., integrated access and backhaul (IAB)) using an F1 interface of the 3GPP system.

The base stations (or cells, DUs, etc.) 510 and 530 of FIG. 5 may be connected to a wireless access point 520 through a wired or wireless Fx interface 570 (or fronthaul). The wireless access point 520 may be configured in form of a transmission and reception point (TRP), remote radio head (RRH), relay, or repeater in the 3GPP system. Here, from the viewpoint of downlink at the terminal, the TRP may be configured to perform both a transmission function and an uplink reception function, or configured to perform either a downlink transmission function or an uplink reception function. In addition, the wireless access point 520 may be configured to perform only an radio frequency (RF) function or to perform some functions (e.g., physical layer and/or MAC layer functions) of the DU of the base station together with the RF function. When some functions of the DU are included in the functions performed by the wireless access point 520, lower functions of the physical layer, functions of the physical layer, and/or lower functions of the MAC layer may be performed by the DU.

Accordingly, the Fx interface 570 between the base station (or cell, DU, etc.) 510 or 530 and the wireless access point 520 may be defined differently depending on which functions of the physical layer and/or MAC layer the wireless access point performs.

Each of the wireless access point 520 of FIG. 5 and the base stations 110-1, 110-2, 110-3, 120-1, 120-2, 510, and 530 shown in FIGS. 1 and 5 may support OFDM, OFDMA, SC -FDMA or NOMA-based downlink transmission and uplink reception. In addition, when the wireless access point of FIG. 5 and the plurality of base stations shown in FIGS. 1 and 5 support a beamforming function using an antenna array by applying a transmission carrier of the mmWave band, each thereof may provide services through beamforming without interference between beams within the base station, and may provide services for a plurality of terminals (or UEs) within one beam.

Also, each of the wireless access point 520 and the plurality of base stations 110-1, 110-2, 110-3, 120-1, 120-2, 510, an 530 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner. The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, operation methods of a communication node in a mobile communication network will be described. Even when a method (e.g., transmission or reception of a signal) performed at a first communication node among communication nodes is described, the corresponding second communication node may perform a method (e.g., reception or transmission of the signal) corresponding to the method performed at the first communication node. That is, when an operation of a terminal is described, the corresponding base station may perform an operation corresponding to the operation of the terminal. Conversely, when an operation of the base station is described, the corresponding terminal may perform an operation corresponding to the operation of the base station.

In the following description, the UPF (or, S-GW) may refer to a termination communication node of the core network that exchanges packets (e.g., control information, data) with the base station, and the AMF (or, MME) may refer to a communication node in the core network, which performs control functions in a radio access section (or, interface) of the terminal. Here, each of the backhaul link, fronthaul link, Xhaul link, DU, CU, BBU block, S-GW, MME, AMF, and UPF may be referred to as a different term according to a function (e.g., function of the Xhaul network, function of the core network) of a communication protocol depending on a radio access technology (RAT).

In order to perform a mobility support function and a radio resource management function, the base station may transmit a synchronization signal (e.g., a synchronization signal/physical broadcast channel (SS/PBCH) block) and/or a reference signal. In order to support multiple numerologies, frame formats supporting symbols having different lengths may be configured. In this case, the terminal may perform a monitoring operation on the synchronization signal and/or reference signal in a frame according to an initial numerology, a default numerology, or a default symbol length. Each of the initial numerology and the default numerology may be applied to a frame format applied to radio resources in which a UE-common search space is configured, a frame format applied to radio resources in which a control resource set (CORESET) #0 of the NR communication system is configured, and/or a frame format applied to radio resources in which a synchronization symbol burst capable of identifying a cell in the NR communication system is transmitted.

The frame format may refer to information of configuration parameters (e.g., values of the configuration parameters, offset, index, identifier, range, periodicity, interval, duration, etc.) for a subcarrier spacing, control channel (e.g., CORESET), symbol, slot, and/or reference signal. The base station may inform the frame format to the terminal using system information and/or a control message (e.g., dedicated control message).

The terminal connected to the base station may transmit a reference signal (e.g., uplink dedicated reference signal) to the base station using resources configured by the corresponding base station. For example, the uplink dedicated reference signal may include a sounding reference signal (SRS). In addition, the terminal connected to the base station may receive a reference signal (e.g., downlink dedicated reference signal) from the base station in resources configured by the corresponding base station. The downlink dedicated reference signal may be a channel state information-reference signal (CSI-RS), a phase tracking-reference signal (PT-RS), a demodulation-reference signal (DM-RS), or the like. Each of the base station and the terminal may perform a beam management operation through monitoring on a configured beam or an active beam based on the reference signal.

For example, the first base station 611 may transmit a synchronization signal and/or a reference signal so that the first terminal 621 located within its service area can search for itself to perform downlink synchronization maintenance, beam configuration, or link monitoring operations. The first terminal 621 connected to the first base station 611 (e.g., serving base station) may receive physical layer radio resource configuration information for connection configuration and radio resource management from the first base station 611. The physical layer radio resource configuration information may mean configuration parameters included in RRC control messages of the LTE communication system or the NR communication system.

For example, the resource configuration information may include PhysicalConfigDedicated, PhysicalCellGroupConfig, PDCCH-Config(Common), PDSCH-Config(Common), PDCCH-ConfigSIB1, ConfigCommon, PUCCH-Config(Common), PUSCH-Config(Common), BWP-DownlinkCommon, BWP-UplinkCommon, ControlResourceSet, RACH-ConfigCommon, RACH-ConfigDedicated, RadioResourceConfigCommon, RadioResourceConfigDedicated, ServingCellConfig, ServingCellConfigCommon, and the like.

The radio resource configuration information may include parameter values such as a configuration (or allocation) periodicity of a signal (or radio resource) according to a frame format of the base station (or transmission frequency), time resource allocation information for transmission, frequency resource allocation information for transmission, a transmission (or allocation) time, or the like. In order to support multiple numerologies, the frame format of the base station (or transmission frequency) may mean a frame format having different symbol lengths according to a plurality of subcarrier spacings within one radio frame. For example, the number of symbols constituting each of a mini-slot, slot, and subframe that exist within one radio frame (e.g., a frame of 10 ms) may be configured differently.

Configuration Information of Transmission Frequency and Frame Format of Base Station

Transmission frequency configuration information: information on all transmission carriers (i.e., cell-specific transmission frequency) in the base station, information on bandwidth parts (BWPs) in the base station, information on a transmission reference time or time difference between transmission frequencies of the base station (e.g., a transmission periodicity or offset parameter indicating the transmission reference time (or time difference) of the synchronization signal), etc.

Frame format configuration information: configuration parameters of a mini-slot, slot, and subframe having a different symbol length according to a subcarrier spacing

Configuration Information of Downlink Reference Signal (e.g., Channel State Information-Reference Signal (CSI-RS), Common Reference Signal (Common-RS), etc.)

Configuration parameters such as a transmission periodicity, transmission position, code sequence, or masking (or scrambling) sequence for a reference signal, which are commonly applied within the coverage of the base station (or beam).

Configuration Information of Uplink Control Signal

Configuration parameters such as a sounding reference signal (SRS), uplink beam sweeping (or beam monitoring) reference signal, uplink grant-free radio resources (or, preambles), etc.

Configuration Information of Physical Downlink Control Channel (e.g., PDCCH)

Configuration parameters such as a reference signal for PDCCH demodulation, beam common reference signal (e.g., reference signal that can be received by all terminals within a beam coverage), beam sweeping (or beam monitoring) reference signal, reference signal for channel estimation, etc.

Configuration Information of Physical Uplink Control Channel (e.g., PUCCH)

Scheduling Request Signal Configuration Information

Configuration information for a feedback (acknowledgement (ACK) or negative ACK (NACK)) transmission resource in a hybrid automatic repeat request (HARD) procedure

Number of antenna ports, antenna array information, beam configuration or beam index mapping information for application of beamforming techniques

Configuration information of downlink signal and/or uplink signals (or uplink access channel resource) for beam sweeping (or beam monitoring)

Configuration information of parameters for beam configuration, beam recovery, beam reconfiguration, or radio link re-establishment operation, beam change operation within the same base station, reception signal of a beam triggering a handover procedure to another base station, timers controlling the above-described operations, etc.

In case of a radio frame format that supports a plurality of symbol lengths for supporting multi-numerology, the configuration (or allocation) periodicity of the parameter, the time resource allocation information, the frequency resource allocation information, the transmission time, and/or the allocation time, which constitute the above-described information, may be information configured for each corresponding symbol length (or subcarrier spacing).

In the following exemplary embodiments, ‘Resource-Config information’ may be a control message including one or more parameters of the physical layer radio resource configuration information. In addition, the ‘Resource-Config information’ may mean attributes and/or configuration values (or range) of information elements (or parameters) delivered by the control message. The information elements (or parameters) delivered by the control message may be radio resource configuration information applied commonly to the entire coverage of the base station (or, beam) or radio resource configuration information allocated dedicatedly to a specific terminal (or, specific terminal group). A terminal group may include one or more terminals.

The configuration information included in the ‘Resource-Config information’ may be transmitted through one control message or different control messages according to the attributes of the configuration information. The beam index information may not express the index of the transmission beam and the index of the reception beam explicitly. For example, the beam index information may be expressed using a reference signal mapped or associated with the corresponding beam index or an index (or identifier) of a transmission configuration indicator (TCI) state for beam management.

Therefore, the terminal operating in the RRC connected state may receive a communication service through a beam (e.g., beam pair) configured between the terminal and the base station. For example, when a communication service is provided using beam configuration (e.g., beam pairing) between the base station and the terminal, the terminal may perform a search operation or a monitoring operation of a radio channel by using a synchronization signal (e.g., SS/PBCH block) and/or a reference signal (e.g., CSI-RS) of a beam configured with the base station, or a beam the can be received. Here, the expression that a communication service is provided through a beam may mean that a packet is transmitted and received through an active beam among one or more configured beams. In the NR communication system, the expression that a beam is activated may mean that a configured TCI state is activated.

The terminal may operate in the RRC idle state or the RRC inactive state. In this case, the terminal may perform a search operation (e.g., monitoring operation) of a downlink channel by using parameter(s) obtained from system information or common Resource-Config information. In addition, the terminal operating in the RRC idle state or the RRC inactive state may attempt to access by using an uplink channel (e.g., a random access channel or a physical layer uplink control channel). Alternatively, the terminal may transmit control information by using an uplink channel.

The terminal may recognize or detect a radio link problem by performing a radio link monitoring (RLM) operation. Here, the expression that a radio link problem is detected may mean that physical layer synchronization configuration or maintenance for a radio link has a problem. For example, the expression that a radio link problem is detected may mean that it is detected that the physical layer synchronization between the base station and the terminal is not maintained during a preconfigured time. When a radio link problem is detected, the terminal may perform a recovery operation of the radio link. When the radio link is not recovered, the terminal may declare a radio link failure (RLF) and perform a re-establishment procedure of the radio link.

The procedure for detecting a physical layer problem of a radio link, procedure for recovering a radio link, procedure for detecting (or declaring) a radio link failure, and procedure for re-establishing a radio link according to the RLM operation may be performed by functions of a layer 1 (e.g., physical layer), a layer 2 (e.g., MAC layer, RLC layer, PDCP layer, etc.), and/or a layer 3 (e.g., RRC layer) of the radio protocol.

The physical layer of the terminal may monitor a radio link by receiving a downlink synchronization signal (e.g., primary synchronization signal (PSS), secondary synchronization signal (SSS), SS/PBCH block) and/or a reference signal. In this case, the reference signal may be a base station common reference signal, beam common reference signal, or terminal (or terminal group) specific reference signal (e.g., dedicated reference signal allocated to a terminal (or terminal group)). Here, the common reference signal may be used for channel estimation operations of all terminals located within the corresponding base station or beam coverage (or service area). The dedicated reference signal may be used for a channel estimation operation of a specific terminal or a specific terminal group located within the base station or beam coverage.

Accordingly, when the base station or the beam (e.g., configured beam between the base station and the terminal) is changed, the dedicated reference signal for beam management may be changed. The beam may be changed based on the configuration parameter(s) between the base station and the terminal. A procedure for changing the configured beam may be required. The expression that a beam is changed in the NR communication system may mean that an index (or identifier) of a TCI state is changed to an index of another TCI state, that a TCI state is newly configured, or that a TCI state is changed to an active state. The base station may transmit system information including configuration information of the common reference signal to the terminal. The terminal may obtain the common reference signal based on the system information. Alternatively, in a handover procedure (handover or ‘reconfiguration with sync’) or connection reconfiguration procedure in which the base station is changed, the base station may transmit a dedicated control message including configuration information of the common reference signal to the terminal. The configured beam information may include at least one of a configured beam index (or identifier), configured TCI state index (or identifier), configuration information of each beam (e.g., transmission power, beam width, vertical angle, horizontal angle), transmission and/or reception timing information of each beam (e.g., subframe index, slot index, mini-slot index, symbol index, offset), reference signal information corresponding to each beam, and reference signal identifier.

In the exemplary embodiments, the base station may be a base station installed in the air. For example, the base station may be installed on an unmanned aerial vehicle (e.g., drone), a manned aircraft, or a satellite.

The terminal may receive configuration information of the base station (e.g., identification information of the base station) from the base station through one or more of an RRC message, MAC message, and PHY message, and may identify a base station with which the terminal performs a beam monitoring operation, radio access operation, and/or control (or data) packet transmission and reception operation.

The result of the measurement operation (e.g., beam monitoring operation) for the beam may be reported through a physical layer control channel (e.g., PUCCH) and/or a MAC message (e.g., MAC CE, control PDU). Here, the result of the beam monitoring operation may be a measurement result for one or more beams (or beam groups). For example, the result of the beam monitoring operation may be a measurement result for beams (or beam groups) according to a beam sweeping operation of the base station.

The base station may obtain the result of the beam measurement operation or the beam monitoring operation from the terminal, and may change the properties of the beam or the properties of the TCI state based on the result of the beam measurement operation or the beam monitoring operation. The beam may be classified into a primary beam, a secondary beam, a reserved (or candidate) beam, an active beam, and a deactivated beam according to its properties. The TCI state may be classified into a primary TCI state, a secondary TCI state, a reserved (or candidate) TCI state, a serving TCI state, a configured TCI state, an active TCI state, and a deactivated TCI state according to its properties. Each of the primary TCI state and the secondary TCI state may be assumed to be an active TCI state and a serving TCI state. The reserved (or candidate) TCI state may be assumed to be a deactivated TCI state or a configured TCI state.

Each of the primary TCI state and the secondary TCI state may be assumed to be an active TCI state or a serving TCI state capable of transmitting or receiving data packets or control signaling even with restriction. In addition, the reserved (or candidate) TCI state may be assumed to be a deactivate TCI state or a configured TCI state in which data packets or control signaling cannot be transmitted or received while being a measurement or management target.

A procedure for changing the beam (or TCI state) property may be controlled by the RRC layer and/or the MAC layer. When the procedure for changing the beam (or TCI state) property is controlled by the MAC layer, the MAC layer may inform the higher layer of information regarding a change in the beam (or TCI state) property. The information regarding the change in the beam (or TCI state) property may be transmitted to the terminal through a MAC message and/or a physical layer control channel (e.g., PDCCH). The information regarding the change in the beam (or TCI state) property may be included in downlink control information (DCI) or uplink control information (UCI). The information regarding the change in the beam (or TCI state) property may be expressed as a separate indicator or field.

The terminal may request to change the property of the TCI state based on the result of the beam measurement operation or the beam monitoring operation. The terminal may transmit control information (or feedback information) requesting to change the property of the TCI state to the base station by using one or more of a PHY message, a MAC message, and an RRC message. The control information (or feedback information, control message, control channel) requesting to change the property of the TCI state may be configured using one or more of the configured beam information described above.

The change in the property of the beam (or TCI state) may mean a change from the active beam to the deactivated beam, a change from the deactivated beam to the active beam, a change from the primary beam to the secondary beam, a change from the secondary beam to the primary beam, a change from the primary beam to the reserved (or candidate) beam, or a change from the reserved (or candidate) beam to the primary beam. The procedure for changing the property of the beam (or TCI state) may be controlled by the RRC layer and/or the MAC layer. The procedure for changing the property of the beam (or TCI state) may be performed through partial cooperation between the RRC layer and the MAC layer.

When a plurality of beams are allocated, one or more beams among the plurality of beams may be configured as beam(s) for transmitting physical layer control channels. For example, the primary beam and/or the secondary beam may be used for transmission and reception of a physical layer control channel (e.g., PHY message). Here, the physical layer control channel may be a PDCCH or a PUCCH. The physical layer control channel may be used for transmission of one or more among scheduling information (e.g., radio resource allocation information, modulation and coding scheme (MCS) information), feedback information (e.g., channel quality indication (CQI), precoding matrix indicator (PMI), HARQ ACK, HARQ NACK), resource request information (e.g., scheduling request (SR)), result of the beam monitoring operation for supporting beamforming functions, TCI state ID, and measurement information for the active beam (or deactivated beam).

The physical layer control channel may be configured to be transmitted through the primary beam of downlink. In this case, the feedback information may be transmitted and received through the primary beam, and data scheduled by the control information may be transmitted and received through the secondary beam. The physical layer control channel may be configured to be transmitted through the primary beam of uplink. In this case, the resource request information (e.g., SR) and/or the feedback information may be transmitted and received through the primary beam.

In the procedure of allocating the plurality of beams (or the procedure of configuring the TCI states), the allocated (or configured) beam indices, information indicating a spacing between the beams, and/or information indicating whether contiguous beams are allocated may be transmitted and received through a signaling procedure between the base station and the terminal. The signaling procedure of the beam allocation information may be performed differently according to status information (e.g., movement speed, movement direction, location information) of the terminal and/or the quality of the radio channel. The base station may obtain the status information of the terminal from the terminal. Alternatively, the base station may obtain the status information of the terminal through another method.

The radio resource information may include parameter(s) indicating frequency domain resources (e.g., center frequency, system bandwidth, PRB index, number of PRBs, CRB index, number of CRBs, subcarrier index, frequency offset, etc.) and parameter(s) indicating time domain resources (e.g., radio frame index, subframe index, transmission time interval (TTI), slot index, mini-slot index, symbol index, time offset, and periodicity, length, or window of transmission period (or reception period)). In addition, the radio resource information may further include a hopping pattern of radio resources, information for beamforming (e.g., beam shaping) operations (e.g., beam configuration information, beam index), and information on resources occupied according to characteristics of a code sequence (or bit sequence, signal sequence).

The name of the physical layer channel and/or the name of the transport channel may vary according to the type (or attribute) of data, the type (or attribute) of control information, a transmission direction (e.g., uplink, downlink, sidelink), and the like.

The reference signal for beam (or TCI state) or radio link management may be a synchronization signal (e.g., PSS, SSS, SS/PBCH block), CSI-RS, PT-RS, SRS, DM-RS, or the like. The reference parameter(s) for reception quality of the reference signal for beam (or TCI state) or radio link management may include a measurement time unit, a measurement time interval, a reference value indicating an improvement in reception quality, a reference value indicating a deterioration in reception quality, or the like. Each of the measurement time unit and the measurement time interval may be configured in units of an absolute time (e.g., millisecond, second), TTI, symbol, slot, frame, subframe, scheduling periodicity, operation periodicity of the base station, or operation periodicity of the terminal.

The reference value indicating the change in reception quality may be configured as an absolute value (dBm) or a relative value (dB). In addition, the reception quality of the reference signal for beam (or TCI state) or radio link management may be expressed as a reference signal received power (RSRP), a reference signal received quality (RSRQ), a received signal strength indicator (RSSI), a signal-to -noise ratio (SNR), a signal-to-interference ratio (SIR), or the like.

Meanwhile, in the NR communication system using a millimeter frequency band, flexibility for a channel bandwidth operation for packet transmission may be secured based on a bandwidth part (BWP) concept. The base station may configure up to 4 BWPs having different bandwidths to the terminal. The BWPs may be independently configured for downlink and uplink. That is, downlink BWPs may be distinguished from uplink BWPs. Each of the BWPs may have a different subcarrier spacing as well as a different bandwidth.

Measurement operations (e.g., monitoring operations) for beam (or TCI state) or radio link management may be performed at the base station and/or the terminal. The base station and/or the terminal may perform the measurement operations (e.g., monitoring operations) according to parameter(s) configured for the measurement operations (e.g., monitoring operations). The terminal may report a measurement result according to parameter(s) configured for measurement reporting.

When a reception quality of a reference signal according to the measurement result meets a preconfigured reference value and/or a preconfigured timer condition, the base station may determine whether to perform a beam (or, radio link) management operation, a beam switching operation, or a beam deactivation (or, activation) operation according to a beam blockage situation. When it is determined to perform a specific operation, the base station may transmit a message triggering execution of the specific operation to the terminal. For example, the base station may transmit a control message for instructing the terminal to execute the specific operation to the terminal. The control message may include configuration information of the specific operation.

When a reception quality of a reference signal according to the measurement result meets a preconfigured reference value and/or a preconfigured timer condition, the terminal may report the measurement result to the base station. Alternatively, the terminal may transmit to the base station a control message triggering a beam (or, radio link) management operation, a beam switching operation (or a TCI state ID change operation, a property change operation), or a beam deactivation operation (or a beam activation operation) according to a beam blockage situation. The control message may request to perform a specific operation.

A basic procedure for beam (or TCI state) management through the radio link monitoring may include a beam failure detection (BFD) procedure, a beam recovery (BR) request procedure, and the like for a radio link. An operation of determining whether to perform the beam failure detection procedure and/or the beam recovery request procedure, an operation triggering execution of the beam failure detection procedure and/or the beam recovery request procedure, and a control signaling operation for the beam failure detection procedure and/or the beam recovery request procedure may be performed by one or more of the PHY layer, the MAC layer, and the RRC layer.

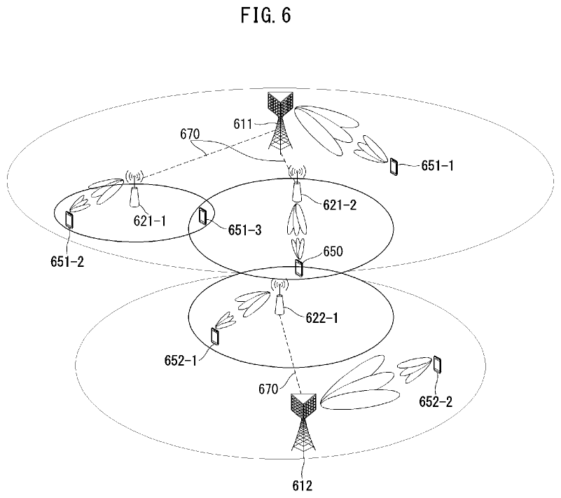

FIG. 6 is a conceptual diagram illustrating an example of a connection scheme for supporting a multi-wireless access point function in a mobile communication system.

Referring to FIG. 6, base stations 611 and 612 may be connected with wireless access points (hereinafter, TRPs) 621-1, 621-2, and 622-1 within each service area through interfaces 670 (e.g., Fx interface or fronthaul) of a wireless or wired scheme, and provide communication services to terminals. The base stations 611 and 612 and the TRPs 621-1, 621-2, and 622-1 may provide communication services to the terminals 650, 651-1, 651-2, 651-3, 652-1, and 652 in each service area through radio links (e.g., Uu interfaces of the 3GPP system). The TRPs 621-1 and 621-2 within the base station 611 for supporting a multi-wireless access point function (hereinafter, a multi-TRP (mTRP) function) may use the same frequency band or use different frequency bands. In addition, the TRPs 621-1 and 621-2 within the base station 611 may operate the same cell having the same physical layer identifier (PCI) or different cells having different PCIs. When the TRP 621-1 and the TRP 621-2 operate in the same frequency band, the terminal 651-3 may be provided with services in a single frequency network (SFN) scheme. Here, the SFN scheme refers to a scheme in which two or more TRPs providing services in the same frequency transmit the same data to the terminal at the same time. In addition, in order to support the mTRP function, two or more TRPs (e.g., 621-2 and 622-1 in FIG. 6) belonging to the different base stations 611 and 612 may provide services to one terminal (e.g., 650 in FIG. 6).

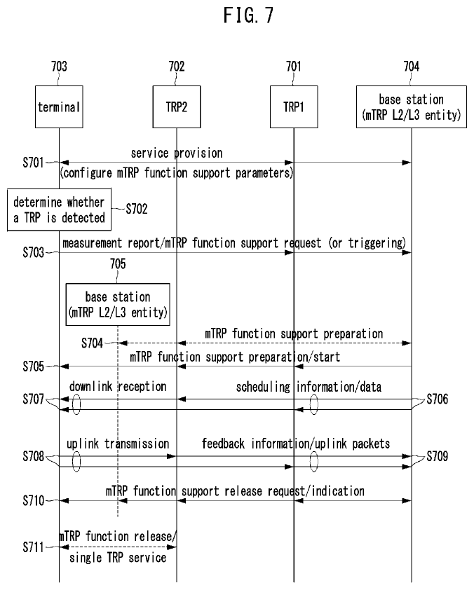

FIG. 7 is a sequence chart for describing an exemplary embodiment of an operation procedure for supporting the mTRP function in a mobile communication system.

A serving base station (or cell or mTRP layer 2/layer 3 (L2/L3) entity) 704 supporting the mTRP function may provide services to a terminal 703 using one or more TRPs (hereinafter referred to as TRPs). The base station may perform operations and procedures for supporting the mTRP function in an entity that controls configuration/operations of a physical layer (or a part of the physical layer) of the TRP (hereinafter, mTRP L2/L3 entity). Here, the function of the mTRP L2/L3 entity may be performed by a MAC layer and/or RRC layer.

The serving base station (or cell or mTRP L2/L3 entity) 704 may deliver parameter(s) for the mTRP function support to the terminal 703 by using an RRC and/or MAC layer control message, and provide services to the terminal 703 by using a TRP1 701 belonging to the base station (S701). That is, the step S701 may be a step in which services are provided using a single TRP (i.e., TRP1). In the step S701, the serving base station 704 may deliver a cell or TRP selection condition for supporting the mTRP function via the TRP1 to the terminal using an RRC message. In the step S701, the serving base station (or cell) may deliver information on neighboring TRP(s) and/or candidate TRP(s) for the mTRP function support to the terminal. Here, the neighboring TRP(s) and/or candidate TRP(s) (e.g., TRP2 702) may be a TRP belonging to the same base station (or cell) as the serving base station 704, or a TRP belonging to another base station (or cell). The information on the neighboring TRP(s) and/or candidate TRP(s) that the base station delivers to the terminal through a dedicated control message and/or system information may include at least one of identifier(s) of the corresponding TRP(s), cell identifier(s) of the TRP(s), configuration information of beam(s) of each TRP (e.g., information on SSB(s) or downlink reference signal identifier(s)), C-RNTI-based scheduling identifier (hereinafter, scheduling identifier or C-RNTI) of the LTE/NR system, or combinations thereof.

The terminal may determine whether TRP(s) satisfying mTRP function support condition(s) (or event) exists while performing a measurement and/or report operation according to measurement/report configuration (S702). Based on quality measurement values of radio channels of the serving cell (or active TRP or serving TRP) currently providing services and detected TRP(s) (or TRP(s) to be added) (hereinafter, detected TRP(s)), the terminal may determine whether each TRP satisfies the mTRP function support condition(s). Parameter(s) for determining whether the mTRP function support condition(s) is satisfied may be configured based on one or more of the following conditions, and the corresponding condition parameter(s) may be delivered to the terminal through the control message and/or system information of the step S701.

When a quality of a radio channel between the terminal and the serving cell (or active TRP or serving TRP) is less than or equal to a reference value

When the terminal is located at an edge of a service coverage of the serving cell (or active TRP or serving TRP)

When a transmission frequency, frequency band, and/or BWP of the detected TRP satisfies a priority for the mTRP function support

When a quality of a radio channel between the terminal and the detected TRP is equal to or greater than a preset reference value

When a quality of a radio channel between the terminal and the detected TRP equal to or greater than a preset reference value is maintained until a predefined timer (e.g., mTRP_AddTimer) expires

Here, whether the terminal is located at the edge of the service coverage of the serving cell (or active TRP or serving TRP) may be determined using a radio channel quality and/or additional information for determining the geographic location of the terminal (e.g., GNSS/GPS information, or geographic location information according to a location estimation scheme using a positioning reference signal (PRS) or the like).

When a TRP (e.g., TRP2) that satisfies the above-described condition(s) is detected and selected, the terminal 703 may transmit a measurement result on the TRP2 to the serving base station (or cell, mTRP L2/L3 entity) 704 via the TRP1 (S703). In the step S703, the terminal 703 may transmit only the measurement result to the serving base station (or cell, mTRP L2/L3 entity) 704 or may transmit a control message requesting mTRP function support to the serving base station (or cell, mTRP L2/L3 entity) 704 by including the measurement result in the control message (S703). Even when a TRP that is not included in the information on the neighboring TRP(s) and/or candidate TRP(s) received in the step S701 but satisfies the mTRP function support condition(s) is detected in the step S702, the terminal may perform the step S703 for the TRP. In the step S703, the terminal may transmit identifier(s) of one or more detected TRP(s), cell identifier(s) (e.g., PCI) of the one or more detected TRPs, and/or one or more beam identifier(s) (e.g., SSB and/or downlink RS identifier) together with the measurement result. The control message for requesting or triggering the mTRP function support in the step S703 may be an RRC message or MAC layer control message (e.g., MAC control element (CE)). When a MAC CE is used, the MAC CE may include a logical channel identifier (LCID) indicating that it is a MAC CE requesting mTRP function support, and may include the TRP identifier(s) and/or cell identifier(s) of the TRP(s) received in the step S701. Here, the MAC CE may include a MAC subheader, a MAC header, a MAC PDU, and/or a MAC subPDU.

Upon receiving the measurement result and/or the triggering message for the mTRP function support from the terminal 703, when the TRP2 belongs to another base station (or cell) 705, the base station 704 may exchange control information for the mTRP function support with the corresponding base station (or, cell or mTRP L2/L3 entity) (S704). The step S704 may be performed when an mTRP L2/L3 entity 705 of the TRP to be added (i.e., TRP2 in FIG. 7) is different from the mTRP L2/L3 entity 704 controlling the TRP1. In addition, when the mTRP L2/L3 entities are different from each other, in the step S704, the related base stations (i.e., 704 and 705 in FIG. 7) may determine an mTRP L2/L3 entity that is to mainly support the mTRP function for the terminal (i.e., 703 in FIG. 7). A base station that will operate an mTRP L2/L3 entity that will primarily support the mTRP function for the corresponding terminal (i.e., 703 in FIG. 7) may be expressed as an ‘mTRP function control base station’.

When the mTRP L2/L3 entities 704 and 705 of the TRP1 and TRP2 that provide the mTRP function for one terminal (703 in FIG. 7) are different from each other, the mTRP L2/L3 entities 704 and 705 may co-operate and determine downlink radio resources (e.g., PDSCH, PDCCH(or CORESET)) and uplink radio resources (e.g., PUCCH, PUSCH) for the mTRP function support, and the mTRP L2/L3 entity of the active TRP may allocate the downlink and/or uplink radio resources to the detected TRP (or added TRP) 702. Hereinafter, ‘active TRP’ may refer to a TRP that performs downlink transmission and/or uplink reception operations for the mTRP function support. To this end, in the step S704, the mTRP L2/L3 entity 704 of the active TRP (i.e., TRP1 in FIG. 7) may deliver, to the mTRP L2/L3 entity 705 of the TRP (i.e., TRP2 in FIG. 7) additionally participating in the mTRP function, the measurement result(s)) on the one or more detected TRP(s) and information on the terminal (e.g., movement speed of the terminal, capability of the terminal, services being provided), which are received from the terminal.

When the TRP2 and TRP1 belong to the same cell or when the TRP2 and TRP1 are operated by the same mTRP L2/L3 entity, the step S704 may be omitted. In addition, even when the TRP2 and TRP1 belong to different cells belonging to the same base station, the step S704 may be omitted. Alternatively, the step S704 may be replaced with a procedure of delivering configuration information of related physical layer parameters for providing the mTRP function (e.g., configuration information of downlink radio resources including CORESET, configuration information of uplink radio resources including PUCCH, configuration information of reference signals such as CRS, TRS, DMRS, and SRS, beam configuration (or TCI state configuration) information, and/or the like).

When the preparation for the mTRP function support is completed, the base station (or cell) may transmit a control message indicating start (or allowance) of the mTRP function support using the TRP1 and TRP2 to the terminal through the TRP1 or TRP2 (S705). In the step S705, the base station may deliver, to the TRP1 and TRP2, a message (or, primitive information) informing that the preparation of the mTRP function support for the terminal 703 is completed or informing the start of the mTRP function support. The control message generated by the base station 704 and delivered to the terminal 703 in the step S705 may be an RRC layer control message, MAC CE, physical layer control message, or combination thereof. When the control message of the step S705 is an RRC message, the mTRP L2/L2 entity of the active TRP may generate and transmit configuration information for the mTRP function support including the above-described related physical layer parameters for providing the mTRP function to the terminal. When the control message of the step S705 is configured as a MAC CE, the mTRP L2/L2 entity of the active TRP may generate and transmit a MAC CE indicating activation of the TRP performing the mTRP operations and/or activation of beam(s) (or TCI state(s)) of the corresponding TRP based on the configuration parameter(s) of the step S701. In this case, the MAC CE may indicate activation of the corresponding TRP/beam (or TCI state) by indicating the TRP/beam (or TCI state) to be activated using a bitmap within a subheader, or by configuring an identifier of the TRP/beam (or TCI state) to be activated as field information of the MAC CE. In addition, as described above, the step S705 may be performed without explicit transmission of the RRC layer/MAC layer control message informing the start (or allowing) of the mTRP function support. That is, when the terminal receives a plurality of physical layer control messages indicating downlink receptions from the plurality of TRPs according to the mTRP function and/or a plurality of physical layer control messages indicating uplink transmissions from the plurality of TRPs according to the mTRP function, the terminal may recognize that the mTRP function support has been started. If the control message corresponding to the step S705 is not received until a preset related timer (e.g., mTRP_Timer) expires, the terminal may determine that the mTRP function support procedure described with reference to FIG. 7 has failed. The mTRP_Timer may be (re)started when the terminal performs the step S703, and may be stopped when the terminal receives the control message of the step S705. If the procedure of FIG. 7 once started fails, the terminal and the base station (or cell) may perform the procedure again from the step S702.

When the TRP1 and TRP2 supporting the mTRP function perform some functions of the physical layer as well as RF functions, the base station 704 may generate scheduling information and downlink data and/or control information according to a functional level of the TRP1 and TRP2, and deliver them to the TRP1 and TRP2 (S706). The TRPs supporting the mTRP function may perform functions such as code block generation, channel coding, rate matching, scrambling, modulation, and/or layer mapping of the physical layer. In this case, according to the functional level performed by the TRPs, the base station may deliver a MAC PDU (or transport block) and scheduling information generated in the MAC layer to the TRPs, deliver a bit stream before being channel-coded to the TRPs, or generate and deliver a channel-coded and/or rate-matched bit stream (or code block), scheduling information (e.g., time/frequency domain resource assignment, MCS information, etc.), DCI and/or UCI for a PDCCH, or control channel elements (CCEs) for a PDCCH to the TRPs.

In addition, the physical layer of the TRP supporting the mTRP function may be configured to include only a HARQ function. In this case, the TRP may perform HARQ buffer management for HARQ retransmission, HARQ process management, HARQ feedback information processing, and/or HARQ retransmission.

In addition, if the TRP supporting the mTRP function is configured to perform only the RF functions without performing the physical layer functions, the base station 704 may transmit downlink packets (i.e., data/control information) through the TRP1 and TRP2 supporting the mTRP function without performing the above-described step S706 (S707).

Through the step S705, the terminal may recognize the start of the mTRP function support using the TRP1 and TRP2. Accordingly, based on the parameter(s) for the mTRP function support received through the control message in the step S705 and/or before the step S705, the terminal may perform downlink reception (data/control information) from the TRP1 and TRP2.

In the step S707 in which the terminal performs downlink reception, the transmissions of the TRP1 and the TRP2 may be performed simultaneously in the same time region and/or frequency region, or may be performed in different time/frequency regions. Here, the same time region may mean the same scheduling timing, and the same frequency region may mean the same transmission frequency, frequency band, and/or BWP.

The terminal supported by the mTRP function may transmit uplink packets (data/control information) to the TRP1 and TRP2 (S708). In the step S708, the transmissions from the terminal to the TRP1 and the TRP2 may be performed simultaneously in the same time region and/or frequency region, or may be performed in different time/frequency regions. As described in the step S706, each TRP may perform functions of a receiving end corresponding to the operation in the step S706 according to radio protocol function configurations of the TRP1 and the TRP2. For example, each TRP may perform descrambling, de-rate matching, channel decoding, and/or MAC PDU extraction on received uplink packets according to its radio protocol function configuration. The TRP1 and TRP2 may transmit a bit stream (or signal stream) or MAC PDU generated through the processing of the uplink packets from the terminal to the base station according to the their physical layer functional levels (S709).

When the TRPs for the mTRP operation operate different cells, information on scheduling identifiers (e.g., C-RNTIs) for scheduling information transmission may be delivered to the terminal in form of the RRC message or MAC CE of the step S705. Alternatively, the C-RNTI may be pre-assigned to the terminal together with parameter configuration information on the neighboring TRP(s) and/or candidate TRP(s) of the step S701. In particular, when the scheduling identifier is delivered through a MAC CE, the MAC CE may be identified using a LCD indicating that it is a MAC CE for assigning a scheduling identifier for the mTRP function support. In addition, the MAC CE may be configured to include cell identifier(s) and/or TRP identifier(s). The same C-RNTI may be applied to TRPs belonging to the same base station in assigning the scheduling identifier for the mTRP function support. That is, in the above-described method, in order to support the mTRP function by TRPs belonging to the same base station, it may be predefined that the same C-RNTI is applied. However, in the case of a terminal receiving the mTRP function from two or more TRPs (e.g., 621-2 and 622-1 in FIG. 6) belonging to different base stations 611 and 612, different scheduling identifiers may be assigned to one terminal (e.g., 650 of FIG. 6).

If necessary to support the mTRP function, the TRP1 and TRP2 may forward downlink data for the terminal or uplink data from the terminal to the counterpart TRP, and may forward downlink scheduling information and/or uplink control information (or feedback information) to the counterpart TRP. Depending on configuration of the radio protocols for the mTRP function support, data forwarding and/or control information forwarding between the TRPs may not be required. That is, the data and/or control information may not be directly forwarded to the counterpart TRP, but may be delivered to a node in which an upper protocol layer (e.g., MAC layer) corresponding to each TRP exists.

If a preconfigured condition(s) for releasing the mTRP function (i.e., mTRP function release condition(s)) is satisfied while supporting the mTRP function, the terminal and/or the base station (or cell) may release the mTRP function by transmitting a control message requesting or indicating release of the mTRP function support (S710). The mTRP function release condition(s) in the step S710 may be transmitted to the terminal using the control message of the step S701 and/or step S705, and may be defined as one or more of the following conditions.

When a quality of radio channel(s) between the TRP(s) and the terminal is less than a reference value until a predefined timer (e.g., mTRP_MaintainTimer) expires

When a random access procedure for the TRP(s) performing the mTRP function fails

When a beam failure recovery (BFR) for the TRP(s) performing mTRP function fails

When the base station (or cell) and/or the mTRP L2/L2 entity decides to release the mTRP function for the TRP

When the terminal requests to release the mTRP function or to change the TRP performing the mTRP function to another TRP

When the TRPs belong to different base stations (or cells) in the step S710, if the TRP1 (i.e., 701 in FIG. 7) is a TRP to be released, the base station (i.e., 704 in FIG. 7) leading the mTRP function and the base station 705 to which the TRP2 belongs may exchange control messages for procedures such as release of the mTRP function support, cell change for the mTRP function support, or handover. In this case, control messages or information for transferring the mTRP L2/L3 entity function for the mTRP function support may be exchanged. When the exchange of the control messages for the mTRP L2/L3 entity function transfer between the base stations 704 and 705 is completed in the step S710, the connection control management function for providing services to the terminal (i.e.,703 in FIG. 7) may be transferred to the base station (i.e., 705 of FIG. 7) to which the TRP2 (i.e., 702 in FIG. 7) belongs. That is, the serving base station (or cell) 705 and the terminal that have released the mTRP function for the TRP1 through the step S710 may maintain services with only one TRP (e.g., TRP2 in FIG. 7) (S711).

In addition to the method of stopping the mTRP function support and providing services using only one TRP as in the step S711 according to the execution of the step S710, if there is a TRP that satisfies the mTRP function support condition(s) of the step S710, the mTRP function support may be continued through a TRP change (or reconfiguration). That is, when the mTRP L2/L3 entity function for the mTRP function support is transferred to the base station 705 of FIG. 7 together with the mTRP function release of the TRP1 in the step S710, and the TRP2 and another added TRP (e.g., TRP3) can provide the mTRP function, the above-described mTRP function may be supported for the terminal using the TRP2 and the TRP3.

When the active TRP is a TRP to be released during the above-described mTRP operation, a TRP change and/or selection (or switching) operation (hereinafter, L2-based TRP selection) may be performed.

If the mTRP function using a plurality of TRPs in the same base station (or cell or mTRP L2/L3 entity) is performed, the L2-based TRP selection may be performed using a MAC CE.

If a quality measurement value of a radio channel of the current serving cell (or active TRP or serving TRP) and the newly detected TRP satisfies the mTRP function support condition(s), the terminal may transmit a MAC CE requesting the L2-based TRP selection. The MAC CE requesting or triggering the L2-based TRP selection (e.g., L2basedTRP_Select MAC CE) may be configured with one or more of the following information.

Identifier of a TRP to be released among the active TRP(s)

Identifier of a newly detected TRP that satisfies the above-described mTRP function support condition(s) among TRP(s) configured for the mTRP function support

Indicator of a target TRP for the mTRP function support

Cell identifier of a detected TRP or target TRP

Activation request indicator for a target TRP

Downlink transmission request for the mTRP function support

Uplink scheduling request for the mTRP function support

Buffer status report (BSR) information of the terminal

Here, the ‘target TRP’ means a TRP selected by the terminal for the purpose of the mTRP function support as a TRP that satisfies the mTRP function support condition(s). In addition, the L2basedTRP_Select MAC CE may be transmitted including beam (or TCI state) identifier information and/or L2 measurement result information for the corresponding TRPs, or may be transmitted in form of a separate MAC CE.

When requesting the L2-based TRP selection for TRP switching (or change) during the mTRP function support, one of the following schemes may be performed.

Scheme 1: L2 TRP (or cell) selection scheme

Scheme 2: L2 triggered TRP (or cell) change scheme

Scheme 3: L2 TRP (or cell) request (or triggering) scheme

Here, Scheme 1 is a scheme in which the terminal selects (or determines) a TRP while supporting the mTRP function. That is, the terminal may transmit the L2basedTRP_Select MAC CE described above to a source TRP or a target TRP to inform a change to the TRP indicated by the TRP identifier in the MAC CE to the base station (or cell or mTRP L2/L3 entity). Here, the ‘source TRP’ means a TRP currently performing the mTRP function.

According to Scheme 1, the terminal may transmit a control signal (e.g., MAC CE or physical layer control signal) indicating TRP selection to a target TRP while transmitting a scheduling request (SR) or buffer status report (BSR), or supporting the mTRP function, thereby notifying to the base station (or cell or mTRP L2/L3 entity) that the terminal selects the TRP (i.e., target TRP) for the mTRP function support. The base station (or cell or mTRP L2/L3 entity) that recognizes the target TRP selected by the terminal according to Scheme 1 may release (or stop) the mTRP function support using the previous TRP (or source TRP), and may use the target TRP selected by the terminal to support the above-described mTRP function.

Scheme 2 is a scheme in which the terminal requests or triggers a cell change (or handover) by transmitting the L2basedTRP_Select MAC CE to the source TRP. The base station (or cell or mTRP L2/L3 entity) obtaining information on the target TRP and/or TRP to be released using the L2basedTRP_Select MAC CE received through the source TRP may release (or stop) the mTRP function support using the source TRP (or TRP to be released) and activate the target TRP selected by the terminal to provide services to the terminal. In this case, the base station (or the mTRP L2/L3 entity or the source TRP) may transmit a MAC CE (or physical layer control signal) indicating activation of the target TRP or downlink/uplink scheduling information (or PDCCH, DCI) to the terminal to activate the target TRP.

Scheme 3 is a scheme in which the terminal transmits the above-described L2basedTRP_Select MAC CE to the source TRP or the target TRP and requests or triggers a change to the TRP indicated by the TRP identifier in the MAC CE to the base station (or cell or mTRP L2/L3 entity). Upon receiving the L2basedTRP_Select MAC CE from the terminal, the L2 layer of the base station may transfer the corresponding control information to the L3 layer of the base station to perform the cell change according to the conventional handover procedure. That is, a procedure in which the mTRP L2/L3 entity of the base station (or cell) performs switching to the TRP indicated by the measurement result of the SRS received from the terminal, the measurement report from the terminal, and/or the L2basedTRP_Select MAC CE may be performed. In addition, the mTRP L2/L3 entity of the base station may deliver internal primitive information indicating the TRP switching (or change) to the L3 layer of the base station while supporting the mTRP function.

In order to support the L2-based TRP selection (or L1/L2 centric mobility) according to the above-described Schemes 1 to 3, configuration of parameters for L2 measurement/reporting is required. Therefore, in the step of configuring the mTRP function support, the base station may transmit configuration information of a measurement target (SSB, CSI-RS, TRS, PRS, etc.) for periodic and/or aperiodic L2 measurement, measurement time, measurement timer for L2 filtering, and/or SRS resources for uplink measurement, and configuration information of L2 events for the L2-based TRP selection.

Here, the SRS resources for uplink measurement may be configured for each TRP or may be configured for all TRPs supporting the mTRP function. However, when the above-described beamforming technique is applied, the measurement target (SSB, CSI-RS, TRS, PRS, etc.) and/or SRS resources for L2 measurement may be configured for each beam.

In addition, the configuration information of the L2 events for L2-based TRP selection may be classified into L2 event(s) based on the SSB, CSI-RS, TRS, and/or PRS initiated by the terminal and L2 event(s) based on the SRS indicated (or triggering) by the base station.

In addition, before initiating the L2-based TRP selection operation according to the above-described Schemes 1 to 3, the terminal may identify a cell identifier or TRP identifier of the candidate TRP, or detected TRP that satisfies the mTRP function support condition(s). When the cell identifier or TRP identifier of the detected TRP is different from a cell identifier or TRP identifier of the TRP previously performing the mTRP operation, the terminal may perform a random access (RA) procedure for transmission of the above-described control information. Here, the above-described control information may mean an RRC layer control message, MAC CE, and/or physical layer control that the terminal transmits to the source TRP or target TRP for the L2-based TRP selection operation described in Scheme 1, Scheme 2, or Scheme 3, and may be expressed as ‘TrpSW_L1/L2_Sig’ below. When the terminal is pre-allocated with a non-contention based (i.e., contention-free)RA resource for the corresponding TRP (or cell or base station), the terminal may perform a contention-free RA procedure using the RA resource. When there is no contention-free resource, the terminal may perform a contention based RA procedure. The terminal may transmit the above-described TrpSW_L1/L2_Sig at the stage of performing the RA procedure or after the RA procedure is completed. The terminal may transmit the TrpSW_L1/L2_Sig using a RA MSG3 of the 4-step RA procedure or a MSG-A payload of the 2-step RA procedure in the RA procedure step. When the TrpSW_L1/L2_Sig is not transmitted (or cannot be transmitted) in the RA procedure step, the terminal may transmit the TrpSW_L1/L2_Sig using an uplink radio resource first transmitted after the RA procedure is completed.

If the L2-based TRP selection to a TRP belonging to another cell within the same DU (or the same gNB/eNB or the same mTRP L2/L3 entity) is requested, the TRP switching (i.e., intra-DU TRP switching) according to the above-described Scheme 1, Scheme 2, or Scheme 3 may be applied.

However, in case of switching between TRPs belonging to different DUs (i.e., inter-DU switching) (or switching between TRPs belonging to different gNB/eNBs or different mTRP L2/L3 entities), if the above-described Scheme 1, Scheme 2, or Scheme 3 is applied, the mTRP L2/L3 entity and/or RRC layer of each base station (or cell) to which the TRP supporting the mTRP function belongs should support the mobility function together.

When applying the above-described Scheme 1 for inter-DU TRP switching, the terminal may transmit TrpSW_L1/L2_Sig to the target TRP in the RA procedure step or after the RA procedure according to the above-described method. The target base station (or cell or mTRP L2/L3 entity) receiving the TRP selection information according to Scheme 1 from the terminal may obtain RRC context (or AS context) of the terminal from the source base station. The source base station and the target base station may determine a primary base station to primarily operate an mTRP L2/L3 entity for the terminal. The primary base station determined through coordination between the target base station and the source base station may support the mTRP function for the terminal through the mTRP L2/L3 entity. In addition, if necessary, the mTRP L2/L3 entity may release (or stop) the mTRP function support of the source TRP (or TRP to be released).

When applying the above-described Scheme 2 or Scheme 3 for inter-DU TRP switching, the terminal may request or trigger a cell change (or handover) by transmitting the L2basedTRP_Select MAC CE to the source TRP. The base station (or cell or mTRP L2/L3 entity) of the source TRP, which obtains the identifier of the target cell, the identifier of the target TRP, and/or beam information (or SSB ID, CSI-RS ID, etc.) from the terminal, may request mTRP function support from the target base station (or cell). In a process in which the base station of the target TRP generates and transmits a response message to the request of the source base station, the source base station and the target base station may determine a base station to primarily operate the mTRP L2/L3 entity for the terminal. Through the response message received from the target base station, the base station of the source TRP may receive radio resource configuration information for the target TRP for the mTRP function support, etc. from the target base station (or cell) and transmit it to the terminal. Here, the information on the target TRP may include allocation or configuration information on parameters such as a RA procedure indicator for the target TRP, a contention-free RA radio resource, a CORESET resource for PDCCH (or DCI) reception, an uplink radio resource, a scheduling identifier (or C-RNTI), a beam (or TCI state), reference signals (CSI-RS, SRS, TRS, DMRS, etc.), and/or the like. Here, the RA procedure indicator information may indicate whether the terminal performs the RA procedure to the target TRP in order to support the mTRP function.

When the RA procedure indicator indicates that the terminal does not need to perform the RA procedure to the target TRP or indicates skipping of the RA procedure, the terminal may use radio resource configuration (or allocation) information of the target TRP received from the source base station to receive the mTRP function support from the target TRP.

However, when the corresponding indicator indicates to perform an RA procedure, the terminal should perform a RA procedure before performing downlink reception from the target TRP and/or uplink transmission to the target TRP. In addition, the target base station may implicitly indicate the RA procedure for the target TRP by delivering contention-free RA radio resource configuration information to the terminal through the source base station without the RA procedure indicator.

When it is necessary to perform the RA procedure, the terminal may perform the RA procedure for the target TRP by using a RA radio resource indicated by the radio resource configuration (or allocation) information received from the source base station or a RA radio resource obtained from system information of the target base station. After completing the random access procedure for the target TRP, the terminal may receive support for the mTRP function from the target TRP.

In addition, when necessary, the mTRP L2/L3 entity of the primary base station or the target base station of the mTRP function may release (or stop) the mTRP function support of the source TRP (or the TRP to be released).

As another method to support the inter-DU TRP switching, a cell (or TRP) change procedure performed by the L3 RRC layer is required, such as the handover procedure of the 3GPP LTE/LTE-A system (or ‘Reconfiguration with sync’ procedure of the NR system). The cell change (or handover or ‘Reconfiguration with sync’) procedure performed by the L3 RRC layer may be in charge of the RRC layer of the serving base station (or cell) that primarily performs the mTRP function for the corresponding terminal. For example, change to a TRP having a different cell identifier (or PCI) within the same DU may be performed according to a PCell (i.e., primary cell) change procedure when a carrier aggregation (CA) function is supported. In addition, change to a TRP having a different cell identifier (or PCI) in different DUs may be performed according to a special cell (i.e., SpCell) change procedure when a dual connectivity (DC) function is supported. Here, the SpCell means a PCell of a master cell group (MCG) or a primary secondary cell group (SCG) cell (i.e., PSCell) of an SCG for the DC function support.

Only downlink resources may be configured in the TRP (i.e., TRP2 in FIG. 7) added while supporting the mTRP function according to the above-described method. Alternatively, even if a PUSCH for uplink transmission is configured, a PUCCH may not be configured. In this case, a PUCCH of the terminal for HARQ feedback information for downlink reception from the added TRP, CSI report, etc. may be transmitted only to the active TRP (i.e., TRP1 701 in FIG. 7). The radio channel quality measurement information, beam measurement information (e.g., TCI state estimation information), etc. for the mTRP function support may be generated and transmitted for each TRP. In order to generate and transmit the radio channel quality measurement information and beam measurement information for the mTRP function support for each TRP, a TRP identifier may be used or an uplink radio resource for reporting the radio channel quality and beam measurement information (e.g., TCI state estimation information) may be allocated for each TRP. When an uplink radio resource is allocated for each TRP, a field parameter of a physical layer downlink control channel (PDCCH or DCI) for transmitting scheduling information of the uplink radio resource may be configured to include a TRP identifier.

In the mTRP function operation or TRP switching operation procedure according to the above-described method, beam (or TCI state) management (hereinafter, TCI state management) may be performed for each of downlink and uplink, and related information may be signaled for each of downlink and uplink. In particular, when a TRP (hereinafter DL-TRP) in charge of downlink transmission is different from a TRP (hereinafter UL-TRP) in charge of uplink reception in support of the mTRP function, a TCI state of downlink and a TCI state of uplink may be separately managed. To this end, the terminal may monitor (or measure) a downlink reference signal (e.g., CSI-RS, SRS, TRS, DMRS, etc.) of the DL-TRP, and transmit a measurement result to the UL-TRP. Based on the measurement result of the downlink reference signal of the DL-TRP received through the UL-TRP, the mTRP L2/L3 entity may manage a TCI state for a downlink channel. The TCI state management may be performed by transmitting TCI state index information to the terminal through a DCI or by transmitting information indicating activation/deactivation for each TCI state index through a MAC CE. In addition, the mTRP L2/L3 entity of the base station may transmit TCI state information of uplink, which is estimated based on an uplink reference signal (e.g., SRS or a reference signal defined for uplink TCI state management) of the terminal, to the terminal by using a PDCCH (or DCI or UCI) and/or MAC CE. Here, the base station (or cell) may transmit uplink TCI state index information to the terminal through a PDCCH (or DCI or UCI) or transmit information indicating activation/deactivation for each uplink TCI state index through a MAC CE, thereby indicating the uplink TCI state management operation. Upon receiving the uplink TCI state information from the base station (or cell, mTRP L2/L3 entity), the terminal may perform uplink transmission using a beam corresponding to the corresponding TCI index.

The above-described TCI state information and/or TCI state indication information for the mTRP function support may be configured to indicate or identify one or more cell identifiers, TRP identifiers, and/or TCI state indexes. For example, the TCI state information and/or TCI state indication information may be configured in form of a bitmap to identify cell(s), TRP(s), and/or TCI state(s). Alternatively, the TCI state information and/or the TCI state indication information may be configured in form of a corresponding cell identifier, TRP identifier, and/or TCI state index. When the TCI state information and/or the TCI state indication information is configured as a bitmap, the cell identifier(s), TRP identifier(s), and/or the TCI state index(es) may be configured to have a correspondence with bits of the bitmap. The correspondence between the bits of the bitmap and the cell identifiers, TRP identifiers, and/or TCI state indexes may be determined according to an order (i.e., order within a list) of the cells and TRPs within the RRC control message configuring the parameters for the mTRP function, or according to an order of participation in the mTRP function support (or the order in which the TRPs were added). Therefore, the terminal may recognize a control signal for a cell or TRP corresponding to the order according to whether each bit value constituting the bitmap is toggled or according to each bit value. For example, if a bit value is ‘1’, it may indicate that a cell, TRP, and/or TCI state corresponding to the corresponding bit is activated or that a related operation needs to be performed for the cell, TRP, and/or TCI state.

In order to perform the TCI state management for the mTRP function support, the terminal may transmit the TCI state index received from the DL-TRP through uplink. In addition, when one or more of the following conditions are satisfied, the terminal may transmit TCI state information (or preferred TCI state index information) for a downlink channel to the base station.

When there is a request from the base station (or cell, mTRP L2/L3 entity)

When a transmission timing according to a periodicity set by the base station arrives

When a TCI state is changed according to a downlink channel monitoring/measurement result of the terminal

When a preconfigured aperiodic TCI state reporting condition is satisfied

In addition, the base station (or cell, mTRP L2/L3 entity) may deliver uplink TCI state information estimated using uplink channel data and reference signals received by the UL-TRP or uplink TCI state index indication information selected by the base station to the terminal. The terminal may select an uplink TCI state index by using the uplink TCI state information received from the base station, or may select an uplink TCI state index according to the TCI state index indication information selected by the base station. Here, selecting a TCI state index means selecting an uplink beam.

On the other hand, when the DL-TRP and UL-TRP are not configured differently, the base station (or cell, mTRP L2/L3 entity) may perform downlink transmission for the terminal by using a downlink beam (or TCI state index) corresponding to an uplink beam (or TCI state index) received from the terminal.

In the mTRP function operation or TRP switching operation according to the above-described method, the base station (or cell, mTRP L2/L3 entity) and/or the terminal may generate preference information for the corresponding operations and deliver it to the counterpart. In addition, the base station (or cell, mTRP L2/L3 entity) may transmit the preference information to another base station participating in the mTRP operation.

The preference information for the mTRP function generated by the base station or the terminal may be composed of one or more of the following parameter(s).

Monitoring/measurement result of a reference signal

Identifier of a detected TRP and/or a state index identifying a beam configured in the detected TRP

Indicator information indicating whether a monitoring/measurement result of a reference signal for a detected TRP satisfies the mTRP function support condition(s)

Best (or preferred) TCI state index for each detected DL-TRP and/or UL-TRP

Monitoring/measurement result of an uplink reference signal (e.g., SRS or a reference signal defined for uplink TCI state management)

In supporting the above-described mTRP function, a method for maintaining uplink physical layer synchronization between the terminal and the TRPs participating in the mTRP function is required. The mTRP L2/L3 entity (or the mTRP function control base station) may generate transmission timing adjustment information (e.g., timing advance (TA) information) of the terminal for maintaining physical layer synchronization between the terminal and each TRP performing the mTRP function based on a measurement result on a physical layer signal (e.g., uplink signal such as SRS and RA preamble), and deliver it to the terminal.

In order to generate and deliver the TA information, the mTRP L2/L3 entity may use one of the following schemes or a combination thereof.

Scheme 1: TA information may be generated and transmitted based on a TRP in which a radio channel quality with the terminal satisfies a preconfigured condition or a TRP indicated to have a radio channel quality equal to or greater than a reference value.

Scheme 2: TA information may be generated and delivered independently for each TRP.

Scheme 3: After generating reference TA information for the TRP selected according to Scheme 1, TA information for another TRP (i.e., TA information for each TRP) may be generated and delivered as an offset value with respect to the reference TA information value.

Scheme 4: TA information may be generated and delivered as a median value of the TAs independently estimated for the respective TRPs according to Scheme 2.

When generating the TA information according to Scheme 1, the mTRP L2/L3 entity may select a TRP in which a radio channel quality with the terminal satisfies a preconfigured condition or a TRP indicated to have a radio channel quality equal to or greater than a reference value. The mTRP L2/L3 entity may generate one TA information (e.g., TA value) by estimating a transmission timing adjustment value of a physical layer uplink channel of the terminal with respect to the selected TRP, and may deliver the TA information to be applied to all TRPs participating in the mTRP function to the terminal. The terminal may adjust a transmission timing of an uplink physical layer channel to each TRP by using the one received TA information, and perform uplink transmission according to the adjusted transmission timing.

When generating the TA information according to Scheme 2, the mTRP L2/L3 entity may generate TA information (or TA value) for each TRP supporting the mTRP function. In addition, the mTRP L2/L3 entity may deliver to the terminal TA information composed of a plurality of TA values generated by the number of TRPs participating in the mTRP function. The terminal may adjust a transmission timing of an uplink physical layer channel for each TRP by using a TA value for each TRP in the received TA information, and perform uplink transmission according to the adjusted transmission timing.

When generating the TA information according to Scheme 3, the mTRP L2/L3 entity may estimate a transmission timing adjustment value (i.e., TA value) of an uplink physical layer channel of the terminal with respect to the TRP selected according to Scheme 1, and configure the corresponding TA value as a reference TA value. In addition, the mTRP L2/L3 entity may generate TA information for the terminal with respect to each TRP participating in the mTRP function. The TA information for each TRP may be configure as an offset value expressed as a difference from the reference TA value, and TA information composed of a plurality of TA values may be generated and delivered to the terminal. The terminal may adjust a transmission timing of an uplink physical layer channel by using the received TA information (e.g., the reference TA value and the offset value from to the reference TA), and perform uplink transmission according to the adjusted transmission timing.

When generating the TA information according to Scheme 4, the mTRP L2/L3 entity may estimate a TA value for maintaining uplink physical layer synchronization for each TRP supporting the mTRP function. In addition, one TA information may be generated as a representative value (e.g., average value or median value) of the TA values estimated for the respective TRPs, and delivered to the terminal. The terminal may adjust a transmission timing of an uplink physical layer channel transmitted for each TRP by using the one TA information (e.g., TA information determined as the median value), and perform uplink transmission according to the adjusted transmission timing.

When the mTRP L2/L3 entity generates and deliver TA information comprising a plurality of TA values as in Scheme 2 or Scheme 3, the TA information may be configured to include each TRP identifier, or the TA information may be configured as a control message in form of a MAC CE or DCI parameter representing a mapping (or association) relation with a TCI state index for the above-described TCI state management, an index of a reference signal used for generation of the TA information, and/or an index of a reference signal for the TCI state management. Here, as the aforementioned mapping (or association) relation between the index and TA information for each TRP (or TA value for each TRP), the aforementioned mapping relationship between the index and TRP identifier may be used. Alternatively, the TA information may be configured with the TA values for the respective TRPs according to an order (or entry order) of the TCI state indexes within the control message configuring the TCI state information. Alternatively, the TRPs supporting the mTRP function may be classified into a primary TRP or a secondary TRP, or a predetermined order may be given to the TRPs supporting the mTRP function. The TA information may be configured by arranging the TA values for the respective TRPs according to the order given to the TRPs within the TRP control message for the mTRP function support.

In the mTRP function operation or TRP switching operation according to the above-described method, the control signal (or message) for triggering or request of the terminal and the response signal of the base station (or mTRP L2/L3 entity) for the control signal (or message) may be exchanged using control signals (or messages) of the same level in the radio protocol layer. For example, when the control signal transmitted by the terminal uses a physical layer control signal, the base station may transmit the response for the corresponding request using a physical layer control signal. Here, the physical layer control signal for triggering or request of the terminal may be transmitted through a PUCCH radio resource, PUCCH information transmitted through a PUSCH radio resource, and/or an uplink radio resource configured/allocated for supporting the mTRP function. In addition, the response signal may be transmitted using a PDCCH (e.g., fields in DCI or DCI defined for the mTRP function support) or a CORESET resource defined for the mTRP function support.

In addition, when the control signal for triggering or request of the terminal is transmitted using a MAC CE, the base station may transmit the response for the request using a MAC CE. Here, the MAC CE transmitted by the terminal or the base station may be composed of an LCD defined for the mTRP function support, MAC (sub) header, MAC (sub) PDU, and the like, and the MAC CE may include information for uplink and information for downlink separately.

In addition, when the control signal transmitted by the terminal uses an RRC control message, the base station may transmit the response for the request using an RRC control message. Here, the RRC control message transmitted by the terminal or the base station may be configured in form of lower information elements in the existing RRC control message for connection control or as a separate RRC control message defined for the mTRP function support.

In the above-described physical layer operation, mTRP function operation, or TRP switching operation, the MAC CE or RRC control message may be configure in form of a bitmap in which each of a plurality of TRPs configured for the mTRP function or cells to which the plurality of TRPs belong sequentially corresponds to one or more bit(s), or may be configure to include an identifier of each TRP (or cell). When the information included in the MAC CE or RRC control message is configured as the bitmap, the bitmap may be configured such that the cell identifiers or TRP identifiers have a sequential correspondence to the bits in the bitmap. The correspondence between the bits in the bitmap and the cell identifiers/TRP identifiers may be determined according to the order of the cells and TRPs within the RRC control message configuring the parameters for the mTRP function (or the order in which the cells or TRPs were added for the mTRP function support). Therefore, the terminal may recognize a control signal for a cell or TRP corresponding to the order according to whether each bit value constituting the bitmap is toggled or according to each bit value. For example, if a bit value is ‘1’, it may indicate that a cell, TRP, and/or TCI state corresponding to the corresponding bit is activated or that a related operation needs to be performed for the cell, TRP, and/or TCI state.

In the present disclosure, a quality of a radio channel may mean a signal quality of a radio channel section, which is expressed as channel state information (CSI), received signal strength indicator (RSSI), reference signal received power (RSRP), reference signal received quality (RSRQ), or signal to interference and noise ratio (SINR). In addition, the measurement result of the present disclosure may be defined or described based on the above-described radio channel quality.

With respect to the operation of the timer defined or described in the present disclosure, although operations such as start, stop, reset, restart, or expire of the defined timer are not separately described, they mean or include the operations of the corresponding timer or a counter for the corresponding timer.

In the present disclosure, the base station (or cell) may refer to a node B (NodeB), an evolved NodeB, a base transceiver station (BTS), a radio base station, a radio transceiver, an access point, an access node, a road side unit (RSU), a radio remote head (RRH), a transmission point (TP), a transmission and reception point (TRP), or a gNB. In addition, the base station (or, cell) may a CU node or a DU node to which the functional split is applied.

In the present disclosure, the terminal may refer to a UE, a terminal, an access terminal, a mobile terminal, a station, a subscriber station, a mobile station, a portable subscriber station, a node, a device), an Internet of Thing (IoT) device, or a mounted apparatus (e.g., a mounted module/device/terminal or an on-board device/terminal).

The exemplary embodiments of the present disclosure may be implemented as program instructions executable by a variety of computers and recorded on a computer-readable medium. The computer-readable medium may include a program instruction, a data file, a data structure, or a combination thereof. The program instructions recorded on the computer-readable medium may be designed and configured specifically for the present disclosure or can be publicly known and available to those who are skilled in the field of computer software.

Examples of the computer-readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a terminal in a mobile communication system, the operation method comprising:
receiving configuration information for support of a multi-transmission and reception point (mTRP) function from a first base station through a first TRP belonging to the first base station;
detecting and selecting a second TRP supporting the mTRP function based on the configuration information;
transmitting a measurement report for the second TRP or a first control message requesting support of the mTRP function in which the second TRP participates to the first base station through the first TRP; and
receiving a second control message indicating a start of the mTRP function in which the first TRP and the second TRP participate from the first base station through the first TRP or the second TRP.

2. The operation method according to claim 1, wherein the configuration information includes information on neighboring TRP(s) and/or candidate TRP(s), and the terminal detects and selects the second TRP based on the information on the neighboring TRP(s) and/or the candidate TRP(s).

3. The operation method according to claim 1, wherein the second TRP is selected based on whether the second TRP satisfies mTRP function support condition(s), and the mTRP function support condition(s) is at least one of:
when a quality of a radio channel between the terminal and the first base station or the first TRP is less than a reference value;
when the terminal is located at an edge of a service coverage of the first base station or the first TRP;
when a transmission frequency, frequency band, and/or bandwidth part (BWP) of the second TRP satisfies a priority for supporting the mTRP function;
when a quality of a radio channel between the terminal and the second TRP is greater than or equal to a preset reference value;
when the quality of the radio channel between the terminal and the second TRP is maintained above a preset reference value until a predefined timer expires; or
a combination thereof.

4. The operation method according to claim 1, wherein the second TRP belongs to the first base station or belongs to a second base station different from the first base station.

5. The operation method according to claim 4, wherein the mTRP function is controlled by an mTRP L2/L3 entity operating in a medium access control (MAC) layer and/or a radio resource control (RRC) layer of the first base station or the second base station.

6. The operation method according to claim 4, further comprising receiving services by the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.

7. The operation method according to claim 6, wherein when the second TRP belongs to the second base station, control information for supporting the mTRP function is exchanged between the first TRP and the second TRP.

8. The operation method according to claim 6, further comprising determining whether the first TRP or the second TRP satisfies mTRP function release condition(s), wherein the mTRP function release condition(s) is at least one of:
when a quality of a radio channel between the terminal and the first TRP or the second TRP is less than a reference value until a predefined timer expires;
when a random access procedure for the first TRP or the second TRP fails;
when a beam failure recovery (BFR) for the first TRP or the second TRP fails;
when the mTRP function control base station and/or an mTRP L2/L3 entity belonging to the mTRP function control base station determines to release the mTRP function for the first TRP or the second TRP;
when the terminal requests release of the mTRP function or requests to change the first TRP or the second TRP to another TRP; or
a combination thereof.

9. The operation method according to claim 8, further comprising, when the first TRP or the second TRP is determined to satisfy the mTRP function release condition(s), transmitting a third control message requesting release of the mTRP function for the first TRP or the second TRP satisfying the mTRP function release condition(s) through the first TRP or the second TRP.

10. The operation method according to claim 8, further comprising, when the first TRP or the second TRP is determined to satisfy the mTRP function release condition(s), performing a procedure of replacing the first TRP or the second TRP satisfying the mTRP function release condition(s) with another newly detected TRP.

11. The operation method according to claim 1, wherein the first message or the second message is one of an RRC control message, a MAC control element (CE), a physical layer control message, or a combination thereof.

12. An operation method of a first base station in a mobile communication system, the operation method comprising:
transmitting configuration information for support of a multi-transmission and reception point (mTRP) function to a terminal through a first TRP belonging to the first base station;
receiving a measurement report for a second TRP detected and selected based on the configuration information or a first control message requesting support of the mTRP function in which the second TRP participates from the terminal through the first TRP; and
transmitting a second control message indicating a start of the mTRP function in which the first TRP and the second TRP participate to the terminal through the first TRP or the second TRP.

13. The operation method according to claim 12, wherein the configuration information includes information on neighboring TRP(s) and/or candidate TRP(s), and the second TRP is detected and selected by the terminal based on the information on the neighboring TRP(s) and/or the candidate TRP(s).

14. The operation method according to claim 12, wherein the second TRP is selected based on whether the second TRP satisfies mTRP function support condition(s), and the mTRP function support condition(s) is at least one of:
when a quality of a radio channel between the terminal and the first base station or the first TRP is less than a reference value;
when the terminal is located at an edge of a service coverage of the first base station or the first TRP;
when a transmission frequency, frequency band, and/or bandwidth part (BWP) of the second TRP satisfies a priority for supporting the mTRP function;
when a quality of a radio channel between the terminal and the second TRP is greater than or equal to a preset reference value;
when the quality of the radio channel between the terminal and the second TRP is maintained above a preset reference value until a predefined timer expires; or
a combination thereof.

15. The operation method according to claim 12, wherein the second TRP belongs to the first base station or belongs to a second base station different from the first base station.

16. The operation method according to claim 15, further comprising providing services based on the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.

17. The operation method according to claim 16, further comprising determining whether the first TRP or the second TRP satisfies mTRP function release condition(s), wherein the mTRP function release condition(s) is at least one of:
when a quality of a radio channel between the terminal and the first TRP or the second TRP is less than a reference value until a predefined timer expires;
when a random access procedure for the first TRP or the second TRP fails;
when a beam failure recovery (BFR) for the first TRP or the second TRP fails;
when the mTRP function control base station and/or an mTRP L2/L3 entity belonging to the mTRP function control base station determines to release the mTRP function for the first TRP or the second TRP;
when the terminal requests release of the mTRP function or requests to change the first TRP or the second TRP to another TRP; or
a combination thereof.

18. A terminal in a mobile communication system, comprising:
at least one processor;
a memory in which instructions executable by the at least one processor are stored; and
a transceiver,
wherein when executed by the at least one processor, the instructions cause the terminal to:
receive configuration information for support of a multi-transmission and reception point (mTRP) function from a first base station through a first TRP belonging to the first base station;
detect and select a second TRP supporting the mTRP function based on the configuration information;
transmit a measurement report for the second TRP or a first control message requesting support of the mTRP function in which the second TRP participates to the first base station through the first TRP; and
receive a second control message indicating a start of the mTRP function in which the first TRP and the second TRP participate from the first base station through the first TRP or the second TRP.

19. The terminal according to claim 18, wherein the second TRP belongs to the first base station or belongs to a second base station different from the first base station.

20. The terminal according to claim 19, wherein the instructions further cause the terminal to receive services by the mTRP function in which the first TRP and the second TRP participate, wherein when the second TRP belongs to the second base station, one of the first base station and the second base station is determined as an mTRP function control base station that controls the mTRP function, and when both of the first TRP and the second TRP belong to the first base station, the first base station is determined as an mTRP function control base station that controls the mTRP function.
